(19) United States
(12) Patent Application Publication
(10) Pub. No.: US 2016/0287048 A1
(43) Pub. Date: Oct. 6, 2016

(54) FILTER FOR A DISHWASHER APPLIANCE

(71) Applicant: General Electric Company, Schenectady, NY (US)

(72) Inventors: Ramasamy Thiyagarajan, Louisville, KY (US); Gregory Owen Miller, Louisville, KY (US); Adam Christopher Hofmann, Louisville, KY (US); John Edward Dries, Louisville, KY (US)

(21) Appl. No.: 14/672,564

(22) Filed: Mar. 30, 2015

(51) Int. Cl. A47L 15/42; B01D 35/30; B29C 67/00; B01D 35/02

(52) U.S. Cl. CPC A47L 15/4202; B01D 35/02; B01D 35/30; B29C 67/0055; B33Y 10/00

(57) ABSTRACT

A filter for dishwasher appliance includes a filter medium, a body extending along an axial direction of the filter, and a cap positioned at a first end of the body along the axial direction of the filter. The filter medium is configured to filter debris and other particles from wash fluid from the wash chamber of the dishwasher appliance and is attached to or formed integrally with the body of the filter. Additionally, the cap is configured to allow a flow of wash liquid from the wash chamber of the dishwasher appliance to the filter medium and may be formed integrally with the body of the filter using an additive manufacturing process.

### FIELD OF THE INVENTION

The present subject matter relates generally to dishwasher appliances, or more particularly to filters for dishwasher appliances.

### BACKGROUND OF THE INVENTION

During wash and rinse cycles, dishwasher appliances generally circulate a fluid through a wash chamber over articles, such as pots, pans, silverware, etc. The fluid can be, e.g., various combinations of water and detergent during the wash cycle or water (which may include additives) during the rinse cycle. Typically, the fluid is circulated during a given cycle using a pump. Fluid is collected at or near a bottom of the wash chamber and pumped back into the wash chamber through, e.g., nozzles in spray arms and other openings that direct the fluid against the articles to be cleaned or rinsed.

Depending upon the level of soil on the articles, fluids used during wash and rinse cycles will become contaminated with soils in the form of debris or particles that are carried with the fluid. In order to protect the pump and recirculate the fluid through the wash chamber, it is beneficial to filter the fluid so that relatively clean fluid is applied to the articles in the wash chamber and materials are removed or reduced from the fluid supplied to the pump.

For example, a filter assembly is typically included for filtering the fluid being supplied to the pump. Such filter assemblies can include a coarse filter in parallel flow with a fine filter. The fine filter typically includes a frame with a fine mesh filter material attached thereto. The filter material is typically a porous material with openings about as wide as the material is thin. Accordingly, the frame may be necessary to ensure the filter assembly maintains a desired shape.

Such filter assemblies typically also include a cap attached to the frame at one end of the frame by, e.g., ultrasonic welding. However, such an attachment method may be time consuming and may also limit the available configurations of filter assemblies. Accordingly, an alternative method for forming a filter assembly that does not require a cap to be attached to the body by ultrasonic welding would be useful.

### BRIEF DESCRIPTION OF THE INVENTION

Aspects and advantages of the invention will be set forth in part in the following description, or may be apparent from the description, or may be learned through practice of the invention.

In a first exemplary embodiment, a filter for a dishwasher appliance defining an axial direction is provided. The filter includes a filter medium oriented generally along the axial direction. The filter medium is configured to filter debris and other particles from wash fluid from a wash chamber of the dishwasher appliance. The filter also includes a body extending along the axial direction between a first end and a second end, the filter medium attached to or formed integrally with the body of the filter. The filter also includes a cap positioned at the first end of the body of the filter and configured to allow a flow of wash liquid from the wash chamber of the dishwasher appliance to the filter medium. The cap of the filter is formed integrally with the body of the filter using an additive manufacturing process.

In a second exemplary embodiment, a filter for a dishwasher appliance defining an axial direction and a radial direction is provided. The filter includes a cap and a body. The body extends along the axial direction between a first end and a second end with the cap positioned at the first end. The body also includes a wall. The filter also includes a filter medium formed integrally with the body using an additive manufacturing process. The filter medium includes a plurality of filter openings defined in the wall of the body configured to filter debris and other particles from wash fluid from a wash chamber of the dishwasher appliance.

In an exemplary aspect, a method for forming a filter for a dishwasher appliance is provided. The method includes determining three-dimensional information of the filter and converting the determined three-dimensional information of the filter into a plurality of slices, each slice of the plurality of slices defining a respective cross-sectional layer of the filter. The method also includes successively forming each cross-sectional layer of the filter with an additive process. After successively forming each cross-sectional layer of the filter with an additive process, the filter includes: (1) a filter medium configured to filter debris and other particles from wash fluid from a wash chamber of the dishwasher appliance; (2) a body extending along an axial direction between a first end and a second end with the filter medium integrated into the body of the filter; and (3) a cap positioned at the first end of the body of the filter.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side, section view of the exemplary dishwasher appliance of FIG. 1.

FIG. 3 provides a perspective view of a filter in accordance with an exemplary embodiment of the present disclosure.

FIG. 4 provides a perspective, partial cutaway view of the exemplary filter of FIG. 3.

FIG. 5 provides a top, cross-sectional schematic view of the exemplary filter of FIG. 3 positioned in a sump in accordance with an exemplary embodiment of the present disclosure.

FIG. 6 provides a top, cross-sectional schematic view of a filter in accordance with another exemplary embodiment of the present disclosure positioned in a sump.

FIG. 7 provides a top, cross-sectional schematic view of a filter in accordance with yet another exemplary embodiment of the present disclosure positioned in a sump.

FIG. 8 provides a top, cross-sectional schematic view of a filter in accordance with still another exemplary embodiment of the present disclosure positioned in a sump.

FIG. 9 provides a top, cross-sectional schematic view of a filter in accordance with another exemplary embodiment of the present disclosure positioned in a sump.

FIG. 10 provides a top, cross-sectional schematic view of a filter in accordance with yet another exemplary embodiment of the present disclosure positioned in a sump.

FIG. 11 provides a top, cross-sectional schematic view of a filter in accordance with still another exemplary embodiment of the present disclosure positioned in a sump.

FIG. 12 provides a top, cross-sectional schematic view of a filter in accordance with another exemplary embodiment of the present disclosure positioned in a sump.

FIG. 13 provides a top, cross-sectional schematic view of a filter in accordance with yet another exemplary embodiment of the present disclosure positioned in a sump.

FIG. 14 provides a top, cross-sectional schematic view of the filter in accordance with still another exemplary embodiment of the present disclosure positioned in a sump.

FIG. 15 provides a top, cross-sectional view of a wall of a body of a filter in accordance with an exemplary embodiment of the present disclosure.

FIG. 16 provides a top, cross-sectional view of a wall of a body of the filter in accordance with another exemplary embodiment of the present disclosure.

FIG. 17 provides a flow diagram of a method for forming a filter in accordance with an exemplary aspect of the present disclosure.

It should be appreciated that the same or similar numbering in the Figures refers to the same or similar components.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

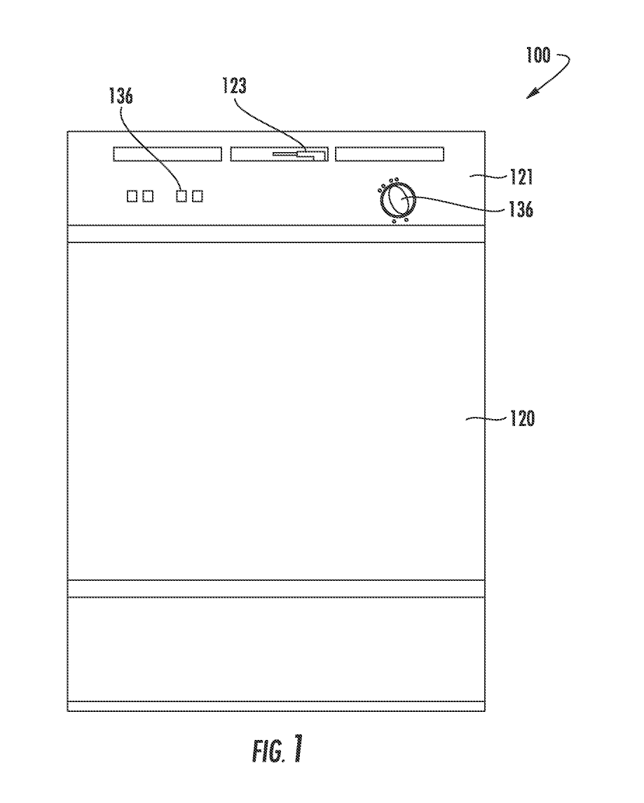

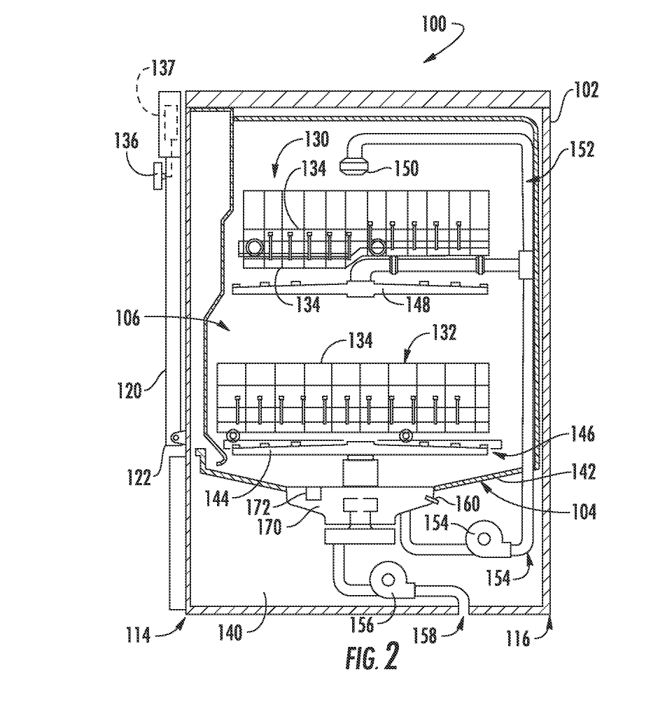

FIGS. 1 and 2 depict a dishwasher appliance 100 according to an exemplary embodiment of the present subject matter. As shown in FIG. 1, dishwasher appliance 100 includes a cabinet 102. Cabinet 102 has a tub 104 therein that defines a wash chamber or compartment 106. The tub 104 also defines a front opening (not shown). Dishwasher appliance 100 includes a door 120 hinged at a bottom 122 of door 120 for movement between a normally closed, vertical position (shown in FIGS. 1 and 2), wherein wash compartment 106 is sealed shut for washing operation, and a horizontal, open position for loading and unloading of articles from dishwasher appliance 100. Latch 123 is used to lock and unlock door 120 for access to wash compartment 106. Tub 104 also includes a sump assembly 170 positioned adjacent a bottom portion 112 of tub 104 and configured for receipt of a liquid wash fluid (e.g., water, detergent, wash fluid, and/or any other suitable fluid) during operation of dishwasher appliance 100. Additionally, dishwasher appliance 100 includes a filter 172 positioned at least partially within sump assembly 170 for filtering particles or other debris from the wash fluid during operation of the dishwasher appliance 100. Notably, in certain exemplary embodiments the filter 172 may be a fine filter and the sump assembly 170 may include a coarse filter. For example, the sump assembly 170 may include a coarse filter extending over a surface of the sump assembly 170 adjacent to the wash compartment 106 and in parallel flow with the filter 172.

A spout 160 is positioned adjacent sump assembly 170 of dishwasher appliance 100. Spout 160 is configured for directing liquid into sump assembly 170. Spout 160 may receive liquid from a water supply, such as a municipal water supply or a well. In alternative embodiments, spout 160 may be positioned at any suitable location within dishwasher appliance 100, e.g, such that spout 160 directs liquid into tub 104. Spout 160 may include a valve (not shown) such that liquid may be selectively directed into tub 104. Thus, for example, during the cycles described below, spout 160 may selectively direct water and/or wash fluid into sump assembly 170 as required by the current cycle of dishwasher appliance 100.

Rack assemblies 130 and 132 are slidably mounted within wash compartment 106. Each of the rack assemblies 130 and 132 is fabricated into lattice structures including a plurality of elongated members 134. Each rack of the rack assemblies 130 and 132 is adapted for movement between an extended loading position (not shown) in which the rack is substantially positioned outside the wash compartment 106, and a retracted position (shown in FIGS. 1 and 2) in which the rack is located inside the wash compartment 106. A silverware basket (not shown) may be removably attached to rack assembly 132 for placement of silverware, utensils, and the like, that are otherwise too small to be accommodated by the racks 130 and 132.

Dishwasher appliance 100 further includes a lower spray assembly 144 that is rotatably mounted within a lower region 146 of the wash compartment 106 and above sump assembly 170 so as to rotate in relatively close proximity to rack assembly 132. A mid-level spray assembly 148 is located in an upper region of the wash compartment 106 and may be located in close proximity to upper rack 130. Additionally, an upper spray assembly 150 may be located above the upper rack 130.

The lower and mid-level spray assemblies 144 and 148 and the upper spray assembly 150 are fed by a fluid circulation assembly 152 for circulating water and dishwasher fluid in the tub 104. Fluid circulation assembly 152 may include a wash or recirculation pump 154 and a cross-flow/drain pump 156 located in a machinery compartment 140 located below sump assembly 170 of the tub 104, as generally recognized in the art. Cross-flow/drain pump 156 is configured for urging wash fluid within sump assembly 170 out of tub 104 and dishwasher appliance 100 to a drain 158. Recirculation pump 154 is configured for supplying a flow of wash fluid from sump assembly 170 to spray assemblies 144, 148 and 150.

Each spray assembly 144 and 148 includes an arrangement of discharge ports or orifices for directing wash fluid onto dishes or other articles located in rack assemblies 130 and 132. The arrangement of the discharge ports in spray assemblies 144 and 148 provides a rotational force by virtue of wash fluid flowing through the discharge ports. The resultant rotation of the lower spray assembly 144 provides coverage of dishes and other dishwasher contents with a spray of wash fluid.

Dishwasher appliance 100 is further equipped with a controller 137 to regulate operation of the dishwasher appliance 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 137 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 137 may be positioned in a variety of locations throughout dishwasher appliance 100. In the illustrated embodiment, controller 137 may be located within a control panel area 121 of door 120 as shown. In such an embodiment, input/output (“I/O”) signals may be routed between the control system and various operational components of dishwasher appliance 100 along wiring harnesses that may be routed through the bottom 122 of door 120. Typically, controller 137 includes a user interface panel 136 through which a user may select various operational features and modes and monitor progress of the dishwasher appliance 100. In one embodiment, user interface 136 may represent a general purpose I/O (“GPIO”) device or functional block. In one embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the subject matter disclosed herein is not limited to any particular style, model or configuration of dishwasher appliance, and that the embodiment depicted in FIGS. 1 and 2 is for illustrative purposes only. For example, instead of the racks 130 and 132 depicted in FIG. 1, dishwasher appliance 100 may be of a known configuration that utilizes drawers that pull out from the cabinet and are accessible from the top for loading and unloading of articles.

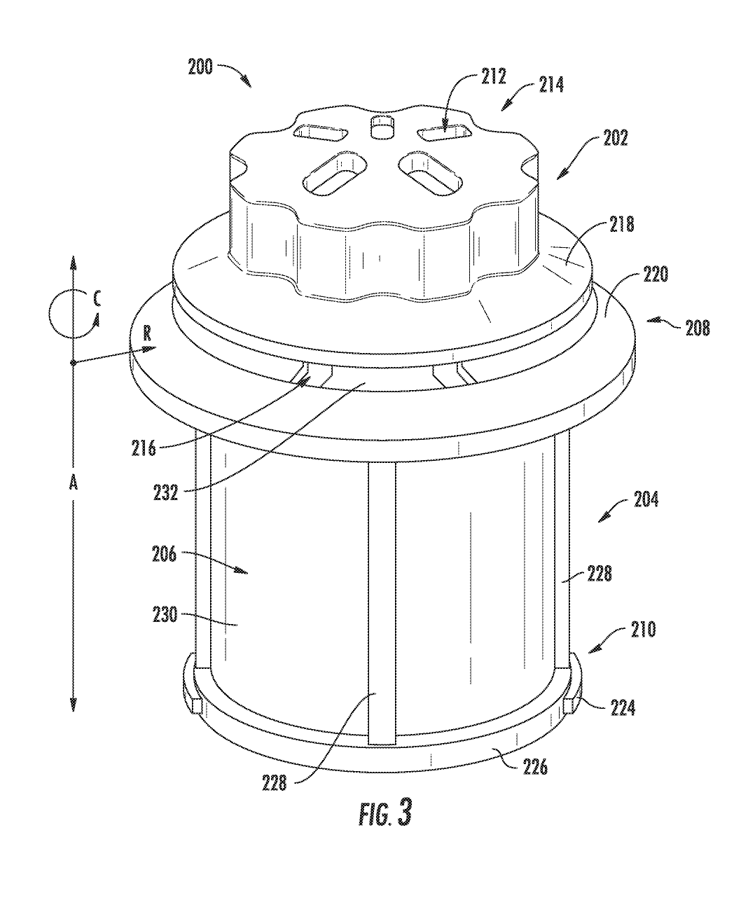

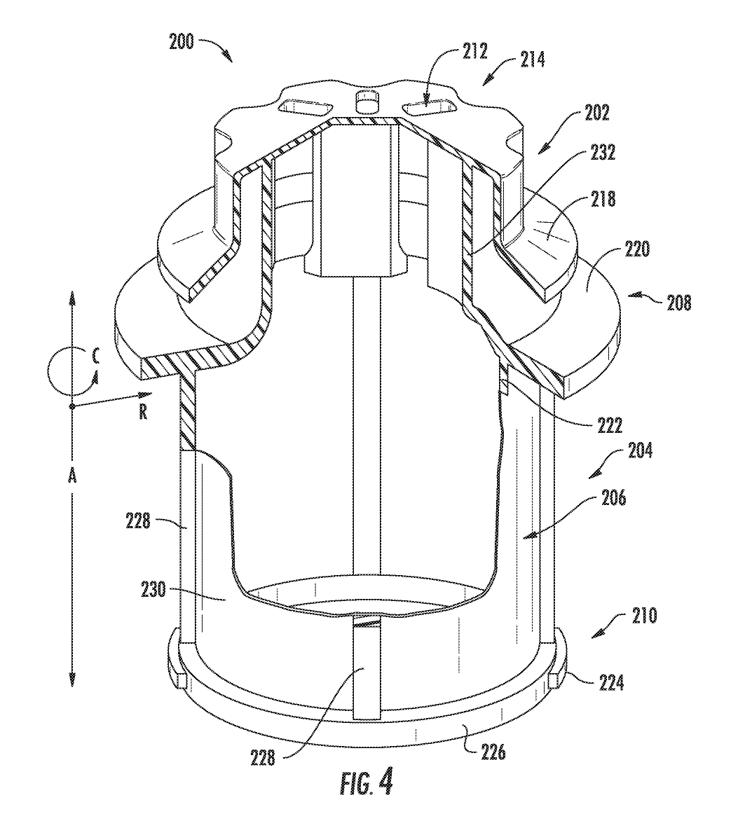

FIGS. 3 and 4 provide a perspective view and a partial cutout view, respectively, of a filter 200 for a dishwasher appliance in accordance with an exemplary embodiment of the present disclosure. The exemplary filter 200 depicted may, in certain exemplary embodiments, be configured as the filter 172 for the dishwasher appliance 100 depicted in FIG. 2.

The filter 200 defines an axial direction A, a radial direction R, and a circumferential direction C, and generally includes a cap 202, a body 204, and a filter medium 206. The body 204 extends generally along the axial direction A between a first end 208 and a second end 210, with the cap 202 positioned at the first end 208 of the body 204. In certain embodiments, the filter 200 may be mounted in a vertical orientation, in which case the axial direction A may extend parallel to the vertical direction.

The cap 202 is configured to allow a flow of wash fluid from a wash chamber of the dishwasher appliance, such as wash chamber 106 of dishwasher appliance 100 (FIG. 2), to the filter medium 206. More particularly, for the embodiment depicted, the cap 202 defines a plurality of inlet openings 212 at an end 214 of the cap 202 opposite the body 204 of the filter 200. Additionally, the cap 202, along with the first end of the body 204 of the filter 200, defines a plurality of inlet slots 216. More particularly, the cap 202 includes a lip 218 extending outwardly along the radial direction R and toward the body 204 of the filter 200. Additionally, the body 204 includes a flange 220 extending outwardly along the radial direction R. The lip 218 of the cap 202 and the flange 220 of the body 204 together define the inlet slots 216 therebetween. During operation of the dishwasher appliance, wash liquid from the wash chamber may flow through one or both of the inlet openings 212 in the cap 202 and the inlet slots 216 defined by the cap 202 and the body 204 to the filter medium 206.

The body 204 of filter 200 additionally includes an upper perimeter rim 222 adjacent to the flange 220 opposite the cap 202. In certain exemplary embodiments, the filter 200 may be configured to fit at least partially within an opening in a sump of the dishwasher appliance, such as the sump assembly 170 of the dishwasher appliance 100 (FIG. 2). In such an embodiment, the flange 220 may sit on top of a perimeter of the opening and the upper perimeter rim 222 may fit within the opening. In such a configuration the flange 220 may form a fluid seal with the perimeter of the opening such that wash fluid must flow through the inlet openings 212 or inlet slots 216 to reach the filter medium 206.

Referring still to the exemplary embodiment of FIGS. 3 and 4, the body 204 of the filter 200 includes one or more attachment features 224 positioned at the second end 210 of the body 204. More particularly, the body 204 additionally includes a lower perimeter rim 226 at the second end 210 of the body 204 with a pair of attachment features 224 extending outwardly along the radial direction R from the lower perimeter rim 226. The pair of attachment features 224 may be configured to interact with a portion of the sump of the dishwasher appliance to secure the filter 200 at least partially within the sump.

The filter medium 206 is oriented generally along the axial direction A and is attached to or formed integrally with the body 204. More particularly, for the embodiment depicted, the body 204 includes one or more posts 228 extending along the axial direction A between the upper perimeter rim 222 and the lower perimeter rim 226 with the filter medium 206 attached to the one or more posts 228. For example, the filter medium 206 may be a fine mesh material 230 attached to the one or more posts 228 of the body 204, such as a stainless steel mesh material, a nylon or other cloth mesh material, or any other suitable mesh material. Such a configuration may ensure filter medium 206 maintains a desired shape during operation of the dishwasher appliance.

Referring particularly to FIG. 4, the body 204 additionally includes a plurality of support struts 232 extending between the first end 208 of the body 204 and the cap 202. For the embodiment depicted, the cap 202 and the body 204 of the filter 200 are formed integrally using an additive manufacturing process. Accordingly, the cap 202 and the body 204 are a single, united piece extending seamlessly between, e.g., the one or more posts 228, the upper perimeter rim 222, the flange 220, the support struts 232, and the cap 202. Accordingly, with such a configuration, the filter 200 may be manufactured without requiring the cap 202 to be attached to the body 204 of the filter 200 using, e.g., an ultrasonic welding attachment method, while maintaining a desired configuration that is not capable of otherwise being formed integrally using, e.g., a molding process. Therefore, the filter 200 may be manufactured more quickly and cost efficiently, while additionally yielding a stronger filter 200 as there are no attachment joints or seams lending themselves to separation under stress.

Referring now briefly to FIG. 5, a top, schematic, cross-sectional view of the filter 200 of FIG. 3, as viewed along the axial direction A, is provided within a sump 234 of the dishwasher appliance, such as sump 170 of dishwasher appliance 100 (FIG. 2). Wash liquid may flow from, e.g., a wash chamber of the dishwasher appliance through one or both of the inlet openings 212 in the cap 202 and the inlet slots 216 defined between the cap 202 and the body 204 into an interior chamber 236 of the filter medium 206. Such wash fluid may then flow through the filter medium 206, wherein particles or other debris larger than the pores or filter openings 238 defined by the filter medium 206 are prevented from flowing therethrough and are thus removed from the flow of wash fluid. As shown, the sump 234 defines an outlet 240, which may be in flow communication with a circulation pump, such as circulation pump 154 of dishwasher appliance 100 (FIG. 2).

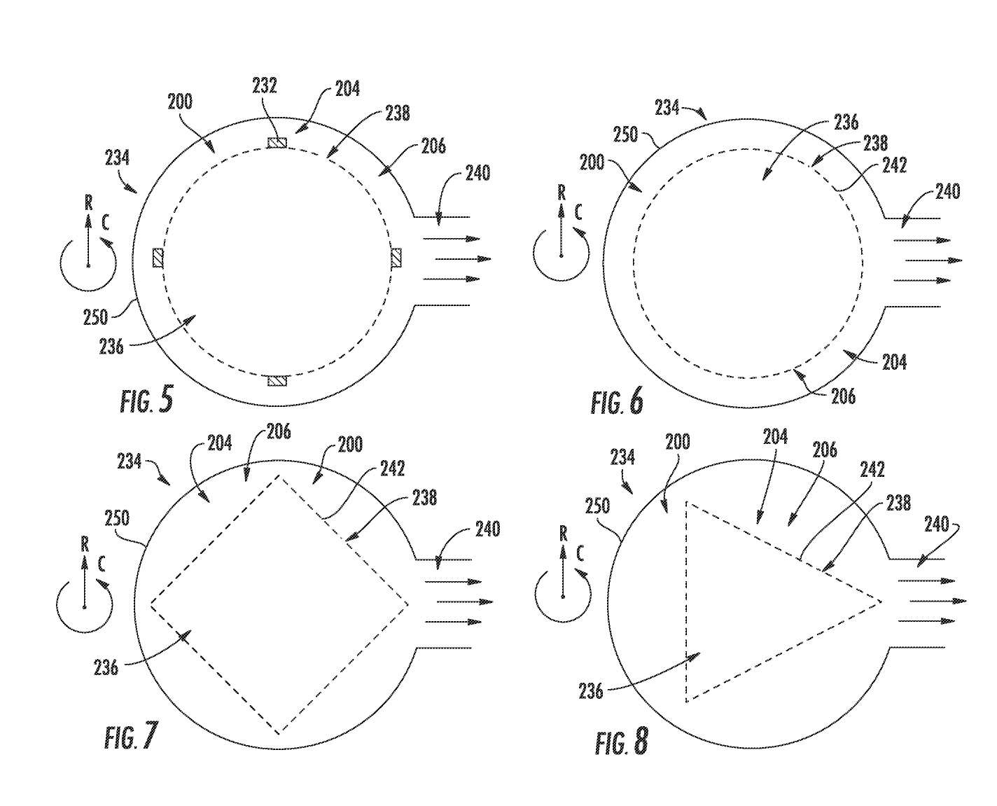

Referring now to the various exemplary embodiments depicted in FIGS. 6 through 14, it should be appreciated that in other exemplary embodiments, the filter medium 206 and body 204 of the filter 200 may instead be formed integrally with one another using an additive manufacturing process such that the filter medium 206 is integrated into the body 204 of the filter 200. More particularly, in certain exemplary embodiments, the body 204 may include a wall 242 and the filter medium 206 may include a plurality of filter openings 238 defined in the wall 242. Each of the exemplary embodiments depicted in FIGS. 6 through 14 are schematic cross-sectional views of the filter 200, as viewed along the axial direction A, with the filter 200 positioned in an exemplary sump 234.

For example, referring first to the exemplary embodiment of FIG. 6, the body 204 defines a cylindrical wall 242 extending along the axial direction A. In such an embodiment, the filter medium 206 includes a plurality of filter openings 238 defined in the wall 242 of the body 204 for filtering debris and other particles from wash fluid from the wash chamber of the dishwasher appliance. As will be discussed below with reference to FIG. 15, the filter openings 238 may be small enough to be fine filter openings, yet the wall 242 may be thick enough to support itself. Accordingly, such a configuration may not require additional posts (such as posts 228) or other structural features.

Alternatively, in other exemplary embodiments, the wall 242 may not be a cylindrical wall 242, and thus may define a non-circular cross-sectional shape as viewed along the axial direction A. For example, referring to FIGS. 7 and 8, the wall 242 of the body 204 may instead define a squared cross-sectional shape as viewed along the axial direction A or a triangular cross-sectional shape as viewed along the axial direction A, respectively. Such a configuration may allow for a crossflow of the wash liquid (i.e., a flow of wash liquid in a direction other than perpendicular to a surface of the wall 242) across the wall 242 and the plurality of filter openings 238 defined therein. A crossflow of the wash fluid across the wall 242 and the plurality of filter openings 238 defined therein may prevent at least a portion of the particles or other debris in the wash fluid from clogging or blocking the plurality of filter openings 238 of the filter medium 206 defined in the wall 242.

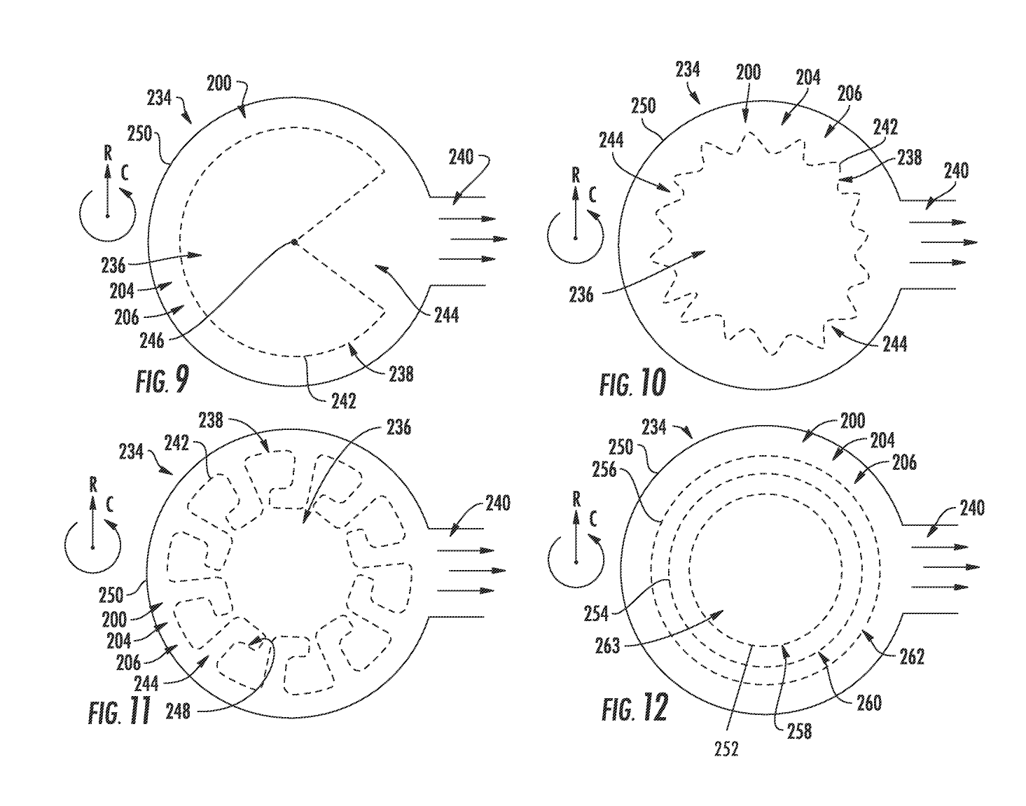

Alternatively still, the wall 242 of the body 204 of the filter 200 may define any other suitable cross-sectional shape as viewed along the axial direction A. For example with reference to FIG. 9, the wall 242 may define a generally circular cross-sectional shape with an indent 244 defined therein. For the embodiment of FIG. 9, the indent 244 is a triangular-shaped indent 244 extending approximately to a center 246 of the body 204 of the filter 200. However in other embodiments, the wall 242 of the body 204 the filter 200 may additionally define a plurality of indents 244 spaced along the circumferential direction C of the filter 200. For example, the exemplary embodiment of FIG. 10 includes a plurality of parabolic shaped indents 244 spaced along the circumferential direction C of the filter 200. Furthermore, with reference now to FIG. 11, the wall 242 of the body 204 of the filter 200 may include one or more indents 244 that include a reference point 248 not visible from an outer portion of the wall 242 of the body 204 of the filter 200 along the radial direction R. More particularly, for the embodiment of FIG. 11, the wall 242 of the body 204 the filter 200 includes a plurality of indents 244 spaced along the circumferential direction C, each including a reference point 248 not visible from an outer portion of the wall 242 of the body 204 of the filter 200 along the radial direction R. It should be appreciated, that as used herein, the term “not visible,” with reference to a reference point, refers to such reference point not defining an unobstructed straight line of sight to a position outside the body 204 of the filter 200, such as to a position on a side wall 250 of sump 234.

Inclusion of one or more indents 244 may increase a total surface area of the wall 242 of the body 204 and filter medium 206, and thus may allow for more efficient filtering of wash fluid from the wash chamber of the dishwasher appliance. Additionally, inclusion of one or more indents 244 may create a crossflow of the wash fluid from the inner chamber 236 of the filter medium 206 through the plurality of filter openings 238 of the filter medium 206 defined in the wall 242. Furthermore, inclusion of one or more indents 244 including a reference point 248 not visible from an outer portion of the wall 242 (FIG. 11) may provide for an even greater increase in the total surface area of the filter medium 206, and may create low-flow areas (e.g., “eddies”) that are less susceptible to being clogged. These low-flow areas may thus act as reserve filter areas for filter 200 when, e.g., a relatively large amount of particles or other debris are being removed from the wash fluid from the wash chamber of the dishwasher appliance.

Alternatively still, in other exemplary embodiments, the body 204 of the filter 200 may include a plurality of walls, each defining an enclosed inner chamber. The plurality of walls of the body 204 may be formed integrally with one another (and with the filter medium 206) using an additive manufacturing process, joined at one or both of a first end 208 or a second end 210 of the body 204. By forming the plurality of walls integrally using an additive manufacturing process, the relatively intricate filter 200 configurations may be formed more quickly and cost efficiently.

For example, with reference to FIG. 12, the body 204 of the filter 200 includes a plurality of walls concentric with one another, i.e., nested within one another. More particularly, the body 204 of the filter 200 includes a first upstream wall 252, a second middle wall 254, and a third downstream wall 256, each formed integrally with one another. Moreover, in such an exemplary embodiment, the filter medium 206 may include a plurality of course filter openings 258 defined in the first upstream wall 252, a plurality of medium filter openings 260 defined in the second middle wall 254, and a plurality of fine filter openings 262 defined in a third downstream wall 256. Accordingly, with such a configuration, wash fluid from the wash chamber of the dishwasher appliance may flow through one or both of the inlet openings 212 in the cap 202 and the inlet slots 216 defined by the cap 202 and body 204 to an interior chamber 263 of the first wall 252. The wash fluid may then flow sequentially through the plurality of course filter openings 258 defined in the first wall 252, the plurality of medium filter openings 260 defined in the second wall 254, and the plurality of fine filter openings 262 defined in the third wall 256. As will be understood, debris and particles in the wash fluid larger than the course filter openings 258 will be prevented from passing through the first wall 252, debris and particles in the wash fluid larger than the medium filter openings 260 will be prevented from passing through the second wall 254, and debris and particles in the wash fluid larger than the fine filter openings 262 will be prevented from passing through the third wall 256. Accordingly, such configuration may sequentially remove particles and other debris from the wash fluid from the wash chamber of the dishwasher appliance.

Alternatively, however, referring now to FIG. 13, in still other exemplary embodiments, the body 204 of the filter 200 may include a plurality of walls defining interior chambers independent from one another. For example, for the exemplary embodiment of FIG. 13 the body 204 of the filter 200 includes a first rectangular shaped wall 264 defining a first interior chamber 266 and a second rectangular shaped wall 268 defining a second interior chamber 270. The first and second rectangular shaped walls 264, 268 are formed integrally with one another, yet the first and second interior chambers 266, 270 are independent from one another. With such an exemplary embodiment, the filter medium 206 includes a plurality of filter openings 238 defined in the first rectangular shaped wall 264 and in the second rectangular shaped wall 268. The filter openings 238 defined in the first rectangular shaped wall 264 and the second rectangular shaped wall 268 may each be fine filter openings. Alternatively, the filter openings 238 defined in one or both of the first rectangular shaped wall 264 and the second rectangular shaped wall 268 may be coarse filter openings. Wash fluid from the wash chamber of the dishwasher appliance may flow through one or both of the inlet openings 212 in the cap 202 and the inlet slots 216 defined by the cap 202 and the body 204 to the first interior chamber 266 of the first rectangular shaped wall 264 and into the second interior chamber 270 of the second rectangular shaped wall 268.

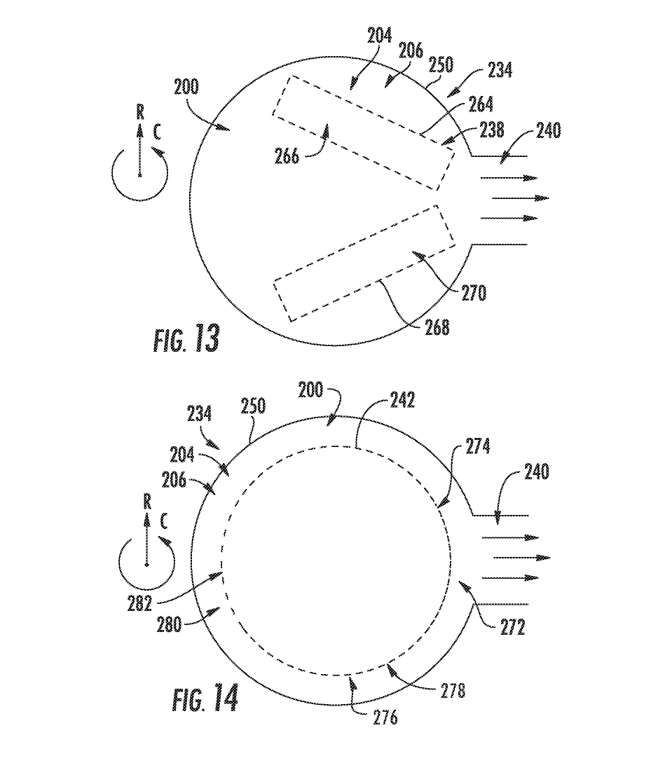

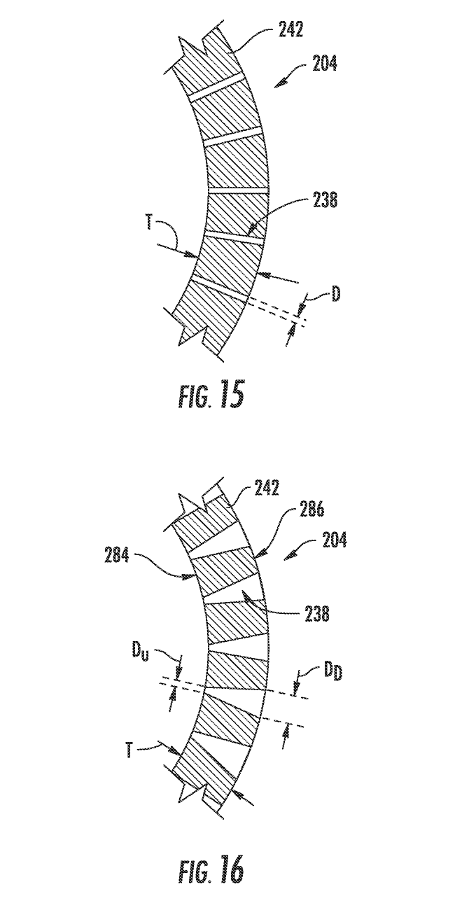

Referring now to FIG. 14 yet another exemplary embodiment of the present disclosure is provided. For the exemplary embodiment depicted, a body 204 of the filter 200 includes a cylindrically shaped wall 242 and a filter medium 206 defines a plurality of filter openings in the wall 242. More particularly, the filter medium 206 defines a fine filter zone 272 including a plurality of fine filter openings 274 defined in the wall 242 of the body 204; two medium filter zones 276 each including a plurality of medium filter openings 278 defined in the wall 242 of the body 204; and a course filter zone 280 including a plurality of course filter openings 282 also defined in the wall 242 of the body 204. For the embodiment depicted, the fine filter zone 272 is positioned proximate to an outlet 240 defined by the sump 234, the course filter zone 280 is positioned furthest away from the outlet 240 defined by the sump 234, and the medium filter zones 276 are defined therebetween. Notably, however, in other exemplary embodiments, the filter medium 206 may define any other suitable number of filter zones positioned at any suitable location. By including a plurality of filter zones in the wall 242 of the body 204, with the fine filter zone 272 proximate the outlet 240 of the sump 234 inlet to the circulation pump, the filter 200 may preferentially filter the wash fluid using the fine filter zone 272, then rely on the medium and coarse filter zones 276, 280 if/when the fine filter zone 272 begins to clog.

Referring now to FIG. 15, a cross-sectional view of an exemplary wall 242 of a body 204 of a filter 200 and a plurality of filter openings 238 of a filter medium 206 defined in the wall 242 of the body 204 are depicted. The exemplary wall 242 and filter openings 238 depicted may represent one or more of the exemplary walls and filter openings depicted schematically in FIGS. 6 through 14.

As shown, the wall 242 of the body 204 defines a thickness T and one or more of the plurality filter openings 238 define a diameter D. For the exemplary embodiment depicted, at least one of the diameters D of the one or more filter openings 238 defined in the wall 242 is less than or equal to about ten percent (10%) of the thickness T of the wall 242 of the body 204. However, in other exemplary embodiments, at least one of the diameters D of the one or more filter openings 238 defined in the wall 242 may instead be less than or equal to about eight percent (8%) of the thickness T of the wall 242 the body 204, or less than or equal to about six percent (6%) of the thickness T of the wall 242 of the body 204. It should be appreciated that as used herein, terms of approximation, such as “about,” refer to being within a ten percent (10%) margin of error.

For example, in certain exemplary embodiments, the thickness T of the wall 242 of the body 204 may be greater than or equal to about eighty (80) thousandths of an inch and at least one of the diameters D of the one or more filter openings 238 defined in the wall 242 may be less than or equal to about eight (8) thousandths of an inch. A filter 200 having such a configuration may allow for the filter medium 206 to be formed integrally with the body 204 of the filter 200 (i.e., integrated into the body 204 of the filter 200), without the need for additional posts other structural supports extending between, e.g, an upper perimeter rim and a lower perimeter rim. More particularly, such a configuration may allow for the wall 242 of the body 204 of the filter 200 to be thick enough such that no additional structural supports are required, while still including a filter medium 206 formed integrally therewith having filter openings 238 defined therein small enough to provide a desired fine filtering of the wash fluid from the wash chamber of the dishwasher appliance.

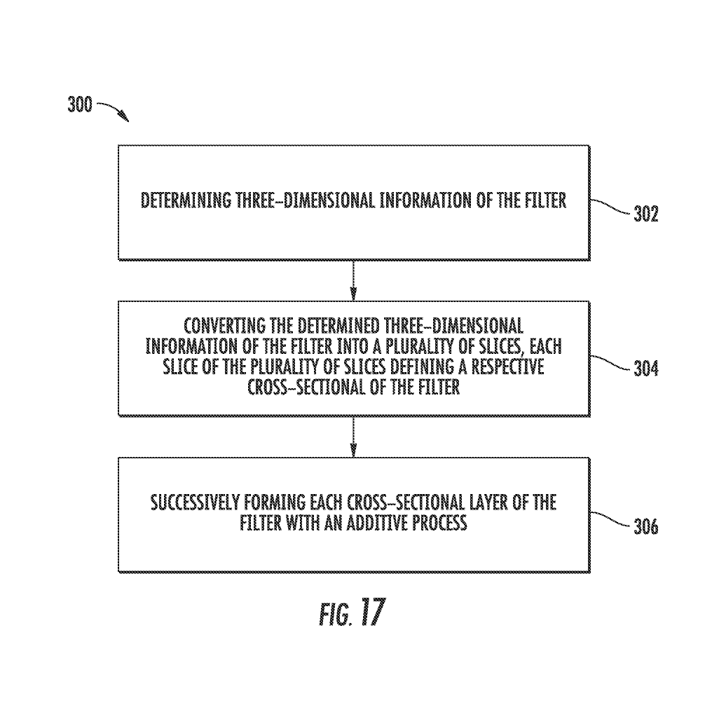

Referring now to FIG. 16, yet another exemplary embodiment of the present disclosure is provided. FIG. 16 provides a cross-sectional view of another exemplary wall 242 of a body 204 of a filter 200 and a plurality of filter openings 238 of a filter medium 206 defined therein. As with the exemplary embodiment of FIG. 15, the exemplary wall 242 and filter openings 238 depicted in FIG. 16 may also represent one or more of the walls and filter openings depicted schematically in FIGS. 6 through 14.

For the embodiment depicted, the wall 242 has an upstream surface 284 and a downstream surface 286. Moreover, one or more of the filter openings 238 defines a first diameter D_{U} at the upstream surface 284 of the wall 242 and a second diameter D_{D} at the downstream surface 286 of the wall 242. For the embodiment depicted, the first diameter D_{U} is less than the second diameter D_{D}. In certain exemplary embodiments, the first diameter D_{U} may be about ten percent (10%) smaller than the second diameter D_{D}, about twenty-five percent (25%) smaller than the second diameter D_{D}, or alternatively may be about fifty percent (50%) smaller than the second diameter D_{D}. A filter 200 having filter openings 238 defined in the wall 242 of the body 204 in accordance with such an embodiment may be less likely to have debris or other particles clogged within the one or more filter openings 238 of the filter medium 206.

Referring now to FIG. 17, a method (300) is illustrated for forming a filter for a dishwasher appliance according to an exemplary embodiment of the present subject matter. Method (300) may be used to form any suitable filter for a dishwasher appliance. For example, method (300) may be used to form one or more of the exemplary filters 200 described above with reference to FIGS. 3 through 16. Method (300) permits formation of various features of the filter, as discussed in greater detail below.

Method (300) includes fabricating the filter as a unitary filter, e.g., such that filter is integrally formed of a single continuous piece of plastic, metal or other suitable material. More particularly, method (300) includes manufacturing or forming filter using an additive process (or additive manufacturing process), such as Fused Deposition Modeling (FDM), Selective Laser Sintering (SLS), Stereolithography (SLA), Digital Light Processing (DLP), Direct Metal Laser Sintering (DMLS), Laser Net Shape Manufacturing (LNSM), electron beam sintering and other known processes. An additive process fabricates plastic or metal components using three-dimensional information, for example a three-dimensional computer model, of the component. The three-dimensional information is converted into a plurality of slices, each slice defining a cross section of the component for a predetermined height of the slice. The component is then “built-up” slice by slice, or layer by layer, until finished.

Accordingly, at (302) three-dimensional information of the filter is determined. As an example, a model or prototype of the filter may be scanned to determine the three-dimensional information of filter at (302). As another example, a model of the filter may be constructed using a suitable CAD program to determine the three-dimensional information of the filter at (302). At (304) the three-dimensional information is converted into a plurality of slices that each defines a cross-sectional layer of the filter. As an example, the three-dimensional information from (302) may be divided into a plurality of equal sections or segments. Thus, the three-dimensional information from (302) may be discretized at (304), e.g., in order to provide planar cross-sectional layers of the filter.

After (304), the filter is fabricated using the additive process, or more specifically each layer is successively formed at (306), e.g., by applying heat to melt and fuse a thermoplastic or by polymerizing a resin using laser energy. The layers may have any suitable size. For example, each layer may have a size between about five ten-thousandths of an inch and about one thousandths of an inch. The filter may be fabricated using any suitable additive manufacturing machine at (306). For example, any suitable laser sintering machine, inkjet printer or laser-jet printer may be used at (306).

Utilizing method (300), the filter may have fewer components and/or joints than known filters. Specifically, the filter may require fewer components because the filter may be a single piece of continuous plastic or metal, e.g., rather than multiple pieces of plastic or metal joined or connected together. In addition, method (300) may permit formation of a filter in accordance with one or more of the exemplary embodiments of the present disclosure discussed above including, for example: a cap formed integrally with a body (FIGS. 3 and 4); a filter medium formed integrally with and integrated into a body (FIG. 6); a body including a wall with a plurality of filter openings defined therein having a noncircular cross-sectional shape (FIGS. 7 through 11); a body formed integrally including a plurality of concentric walls each with a plurality of filter openings defined therein (FIG. 12); body formed integrally including a plurality of walls with non-overlapping interior chambers each with a plurality of filter openings defined therein (FIG. 13); a body including a wall integrally formed with a filter medium defining a plurality of different filter zones in the wall (FIG. 14); a body including a wall with a plurality of filter openings defined therein having a desired aspect ratio (FIG. 15); and/or a body including a wall defining an upstream surface and a downstream surface, including a plurality of filter openings defined therein, with at least one of the filter openings defining a diameter at the upstream surface that is less than a diameter of the respective opening at the downstream surface (FIG. 16).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A filter for a dishwasher appliance defining an axial direction, the filter comprising:
a filter medium oriented generally along the axial direction, the filter medium configured to filter debris and other particles from wash fluid from a wash chamber of the dishwasher appliance;
a body extending along the axial direction between a first end and a second end, the filter medium attached to or formed integrally with the body of the filter; and
a cap positioned at the first end of the body of the filter and configured to allow a flow of wash liquid from the wash chamber of the dishwasher appliance to the filter medium, the cap of the filter formed integrally with the body of the filter using an additive manufacturing process.

2. The filter of claim 1, wherein the body includes one or more posts extending along the axial direction, and wherein the filter medium is a mesh material attached to the one or more posts of the body.

3. The filter of claim 1, wherein the filter medium and the body are formed integrally using an additive manufacturing process.

4. The filter of claim 3, wherein the body includes a wall, and wherein the filter medium includes a plurality of filter openings defined in the wall of the body for filtering debris and other particles from wash fluid from the wash chamber.

5. The filter of claim 4, wherein the wall of the body defines a thickness, and wherein one or more of the plurality of filter openings define a diameter less than or equal to about ten percent (10%) of the thickness of the wall of the body.

6. The filter of claim 5, wherein the thickness of the wall of the body is greater than or equal to about eighty (80) thousandths of an inch.

7. The filter of claim 3, wherein the body includes a wall, wherein the filter medium defines a fine filter zone comprised of a plurality of fine filter openings defined in the wall of the body, wherein the filter medium further defines a coarse filter zone comprised of a plurality of coarse filter openings also defined in the wall of the body.

8. The filter of claim 3, wherein the body includes a wall having an upstream surface and a downstream surface, wherein the filter medium comprises a plurality of filter openings defined in the wall, and wherein one or more of the filter openings defines a diameter at the upstream surface of the wall that is less than a diameter of the respective filter opening at the downstream surface of the wall.

9. The filter of claim 3, wherein the body includes an upstream wall and a downstream wall, the upstream wall concentric with the downstream wall and formed integrally with the downstream wall, wherein the filter medium comprises a plurality of coarse filter openings in the upstream wall, and wherein the filter medium further comprises a plurality of fine filter openings in the downstream wall.

10. The filter of claim 3, wherein the body includes a wall defining a non-circular cross-sectional shape as viewed along the axial direction.

11. The filter of claim 3, wherein the filter further defines a radial direction, wherein the body includes a wall and the filter medium includes a plurality of filter openings defined in the wall of the body, wherein the wall defines a cross-sectional shape as viewed along the axial direction having an indent, the indent including a reference point not visible from an outer portion of the wall along the radial direction.

12. A filter for a dishwasher appliance defining an axial direction and a radial direction, the filter comprising:
a cap;
a body extending along the axial direction between a first end and a second end with the cap positioned at the first end, the body including a wall; and
a filter medium formed integrally with the body using an additive manufacturing process, the filter medium comprising a plurality of filter openings defined in the wall of the body configured to filter debris and other particles from wash fluid from a wash chamber of the dishwasher appliance.

13. The filter of claim 12, wherein the wall of the body defines a thickness along the radial direction, and wherein one or more of the plurality of filter openings define a diameter less than or equal to about ten percent (10%) of the thickness of the wall of the body.

14. The filter of claim 13, wherein the thickness of the wall of the body is greater than or equal to about eighty (80) thousandths of an inch.

15. The filter of claim 12, wherein cap is formed integrally with the body and the filter medium using an additive manufacturing process.

16. The filter of claim 12, wherein the filter medium defines a fine filter zone comprised of a plurality of fine filter openings defined in the wall of the body, and wherein the filter medium further defines a coarse filter zone comprised of a plurality of coarse filter openings also defined in the wall of the body

17. The filter of claim 12, wherein the wall of the body defines an upstream surface and a downstream surface, wherein the filter medium comprises a plurality of filter openings defined in the wall, and wherein one or more of the filter openings define a diameter at the upstream surface of the wall that is less than a diameter of the respective filter opening at the downstream surface of the wall.

18. The filter of claim 12, wherein the wall of the body is an upstream wall, wherein the body further includes a downstream wall concentric with the upstream wall and formed integrally with the upstream wall, wherein the filter medium comprises a plurality of coarse filter openings in the upstream wall, and wherein the filter medium further comprises a plurality of fine filter openings in the downstream wall.

19. A method for forming a filter for a dishwasher appliance, comprising:
determining three-dimensional information of the filter;
converting the determined three-dimensional information of the filter into a plurality of slices, each slice of the plurality of slices defining a respective cross-sectional layer of the filter; and
successively forming each cross-sectional layer of the filter with an additive process;
wherein, after successively forming each cross-sectional layer of the filter with an additive process, the filter includes: (1) a filter medium configured to filter debris and other particles from wash fluid from a wash chamber of the dishwasher appliance; (2) a body extending along an axial direction between a first end and a second end with the filter medium integrated into the body of the filter; and (3) a cap positioned at the first end of the body of the filter.

20. The method of claim 19, wherein the additive process comprises at least one of fused deposition modeling, selective laser sintering, stereolithography, and digital light processing.
